(19) United States
(12) Patent Application Publication
(10) Pub. No.: US 2024/0001933 A1
(43) Pub. Date: Jan. 4, 2024

(54) OCCUPANT TEMPERATURE ESTIMATING DEVICE, OCCUPANT STATE DETECTION DEVICE, OCCUPANT TEMPERATURE ESTIMATING METHOD, AND OCCUPANT TEMPERATURE ESTIMATING SYSTEM

(71) Applicant: Mitsubishi Electric Corporation, Tokyo (JP)

(72) Inventors: Hirotaka SAKAMOTO, Tokyo (JP); Toshiyuki HATTA, Tokyo (JP)

(73) Assignee: Mitsubishi Electric Corporation, Tokyo (JP)

(21) Appl. No.: 18/029,511

(22) PCT Filed: Dec. 4, 2020
(86) PCT No.: PCT/JP2020/045315

§ 371 Date: Mar. 30, 2023

(51) Int. Cl. B60W 40/08; G06V 20/59

(52) U.S. Cl. CPC B60W 40/08; G06V 20/59; B60W 2540/221

(57) ABSTRACT

Included are: a temperature image acquiring unit that acquires a temperature image; a binarization processing unit that sets at least one temperature candidate region in a target region included in a region of the temperature image, by binarizing pixels in the target region on the basis of temperature information possessed by the pixels in the target region; a candidate region temperature calculating unit that calculates a region temperature for the temperature candidate region in the target region on the basis of temperature information possessed by a pixel in the temperature candidate region; and a temperature estimating unit that determines a temperature region from among the at least one temperature candidate region on the basis of a separation degree calculated for the temperature candidate region in the target region, and estimates that a temperature of a body part of an occupant is the region temperature for the temperature region.

### TECHNICAL FIELD

The present disclosure relates to an occupant temperature estimating device, an occupant state detection device, an occupant temperature estimating method, and an occupant temperature estimating system.

### BACKGROUND ART

Conventionally in a vehicle, a technique of estimating a temperature of a body part of an occupant in a vehicle interior and performing various controls for air conditioning or the like using the estimated temperature is known. Note that the temperature of the body part of the occupant here is a surface temperature of the body part of the occupant.

As a technique of estimating the temperature of the body part of the occupant in the vehicle interior, there is a technique of performing image processing on a temperature image such as an infrared image acquired from a sensor that detects a temperature in the vehicle interior, and estimating the temperature of the body part of the occupant on the basis of an infrared intensity (for example, Patent Literature 1).

### CITATION LIST

### Patent Literature

Patent Literature 1: WO 2019/187712 A

### SUMMARY OF INVENTION

### Technical Problem

In the vehicle interior, there is a heat source other than the body part of the occupant. Therefore, when the temperature of the body part of the occupant is estimated simply on the basis of the temperature in the temperature image, there is a problem that a temperature due to a heat source other than the body part of the occupant may be erroneously estimated as the temperature of the body part of the occupant. In particular, in a temperature image having a low resolution, erroneous estimation as described above is likely to occur.

The present disclosure has been made in order to solve the above problem, and an object of the present disclosure is to provide an occupant temperature estimating device capable of enhancing estimation accuracy of a temperature of a body part of an occupant based on a temperature image as compared with a conventional temperature estimating technique based on the temperature image.

### Solution to Problem

An occupant temperature estimating device according to the present disclosure includes: a temperature image acquiring unit that acquires a temperature image which is obtained by imaging a vehicle interior and whose pixels each have temperature information; a binarization processing unit that sets at least one temperature candidate region in a target region from which a temperature of a body part of an occupant present in the vehicle interior is to be estimated, by binarizing pixels in the target region on the basis of the temperature information possessed by the pixels in the target region, the target region being included in a region of the temperature image acquired by the temperature image acquiring unit; a candidate region temperature calculating unit that calculates a region temperature for the temperature candidate region in the target region on the basis of the temperature information possessed by a pixel in the temperature candidate region; and a temperature estimating unit that determines a temperature region from among the at least one temperature candidate region on the basis of a separation degree indicating how much the temperature information possessed by the pixel in the temperature candidate region stands out from the temperature information possessed by a pixel in a region other than the temperature candidate region in the target region, the separation degree being calculated for the temperature candidate region in the target region, and estimates that the temperature of the body part of the occupant is the region temperature for the temperature region.

### Advantageous Effects of Invention

According to the present disclosure, estimation accuracy of a temperature of a body part of an occupant based on a temperature image can be enhanced as compared with a conventional temperature estimating technique based on the temperature image.

### BRIEF DESCRIPTION OF DRAWINGS

FIG. 1 is a diagram illustrating a configuration example of an occupant temperature estimating system according to a first embodiment.

FIGS. 2A and 2B are diagrams schematically illustrating a concept when a sensor images a vehicle interior and thereby obtains a temperature image in the first embodiment, in which FIG. 2A is a diagram for explaining a concept of a situation in the vehicle interior in an imaging region of the sensor, and FIG. 2B is a diagram for explaining a concept of a temperature image imaged by the sensor under the situation illustrated in FIG. 2A.

FIG. 3 is a diagram illustrating a configuration example of an occupant temperature estimating device according to the first embodiment.

FIG. 4 is a diagram illustrating an example of a concept of a temperature image acquired by a temperature image acquiring unit in the first embodiment.

FIG. 5 is a diagram illustrating an example of a concept of a target region extracted from the temperature image illustrated in FIG. 4 by a target region extracting unit in the first embodiment.

FIG. 6 is a diagram for explaining concepts of first Otsu's binarization and second Otsu's binarization performed by a binarization processing unit in the first embodiment.

FIG. 7 is a diagram for explaining a concept of an example of a label image after the binarization processing unit sets a temperature candidate region and assigns a region label to the set temperature candidate region in the first embodiment.

FIG. 8 is a diagram for explaining a concept in which a candidate region temperature calculating unit classifies, on the basis of a candidate region post-setting temperature image and a label image, temperature candidate regions in the candidate region post-setting temperature image into regions of respective region labels assigned to the temperature candidate regions in the first embodiment.

FIG. 9 is a diagram for explaining a concept in which the candidate region temperature calculating unit calculates a region temperature for a classified temperature region in the first embodiment.

FIG. 10 is a diagram illustrating a concept of an example of calculation of a separation degree by a temperature estimating unit in the first embodiment.

FIG. 11 is a diagram for explaining a concept of a machine learning model used when a reliability estimating unit estimates a reliability in the first embodiment.

FIG. 12 is a diagram for explaining information to be an input to the machine learning model in detail in the first embodiment.

FIG. 13 is a flowchart for explaining an operation of the occupant temperature estimating device according to the first embodiment.

FIG. 14 is a diagram illustrating a configuration example of an occupant temperature estimating device that determines whether or not estimated temperatures of a hand and a face of an occupant are reliable in consideration of a situation of the occupant, and a configuration example of an occupant temperature estimating system including the occupant temperature estimating device in the first embodiment.

FIGS. 15A and 15B are diagrams for explaining concepts of examples of situations of an occupant when an estimation result determining unit determines to adopt the temperature of the face of the occupant estimated by the temperature estimating unit and when the estimation result determining unit determines not to adopt the temperature of the face of the occupant estimated by the temperature estimating unit, respectively.

FIG. 16 is a flowchart for explaining an operation of the occupant temperature estimating device that determines whether or not the estimated temperatures of the hand and the face of the occupant are reliable in consideration of a situation of the occupant in the first embodiment.

FIG. 17 is a diagram illustrating a configuration example of an occupant state detection device including the occupant temperature estimating device according to the first embodiment.

FIG. 18 is a flowchart for explaining an operation of the occupant state detection device according to the first embodiment.

FIGS. 19A and 19B are diagrams each illustrating an example of a hardware configuration of the occupant temperature estimating device according to the first embodiment.

### DESCRIPTION OF EMBODIMENTS

Hereinafter, an embodiment of the present disclosure will be described in detail with reference to the drawings.

### First Embodiment

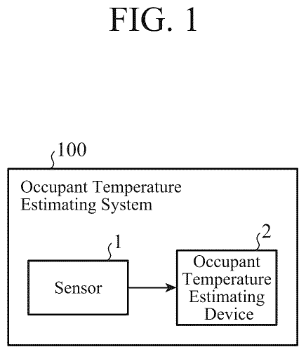

FIG. 1 is a diagram illustrating a configuration example of an occupant temperature estimating system 100 according to a first embodiment.

The occupant temperature estimating system 100 estimates a temperature of a body part of an occupant present in a vehicle interior on the basis of a temperature image obtained by imaging the vehicle interior.

In the first embodiment, the temperature of the body part of the occupant is a surface temperature of the body part of the occupant. The body part of the occupant is specifically a hand or a face of the occupant.

The occupant is assumed to be a driver in the following first embodiment, as an example.

The occupant temperature estimating system 100 includes a sensor 1 and an occupant temperature estimating device 2.

The sensor 1 is, for example, an infrared array sensor.

The sensor 1 is mounted on a vehicle, and acquires a temperature image by imaging a vehicle interior. The sensor 1 is disposed at a position where the sensor 1 can image a region including a hand and a face of an occupant in the vehicle interior. That is, an imaging region of the sensor 1 includes the region including the face and the hand of the occupant.

In the first embodiment, the temperature image imaged by the sensor 1 may have a medium resolution. Specifically, the number of pixels of the temperature image only needs to be, for example, about 100×100 pixels or less. Therefore, a relatively inexpensive sensor such as a thermopile can be used as the sensor 1. The sensor 1 may be shared with a so-called “Driver Monitoring System (DMS)”.

Each pixel of the temperature image imaged by the sensor 1 has temperature information. The temperature information is represented by a numerical value.

The occupant temperature estimating device 2 estimates a temperature of the hand or the face of the occupant on the basis of the temperature image imaged by the sensor 1.

In the following first embodiment, as an example, it is assumed that the occupant temperature estimating device 2 estimates the temperatures of the hand and the face of the occupant on the basis of the temperature image. Note that this is merely an example, and the occupant temperature estimating device 2 may estimate the temperature of at least one of the hand and the face of the occupant. The temperature of the hand of the occupant estimated by the occupant temperature estimating device 2 may be the temperature of one hand of the occupant or the temperatures of both hands of the occupant.

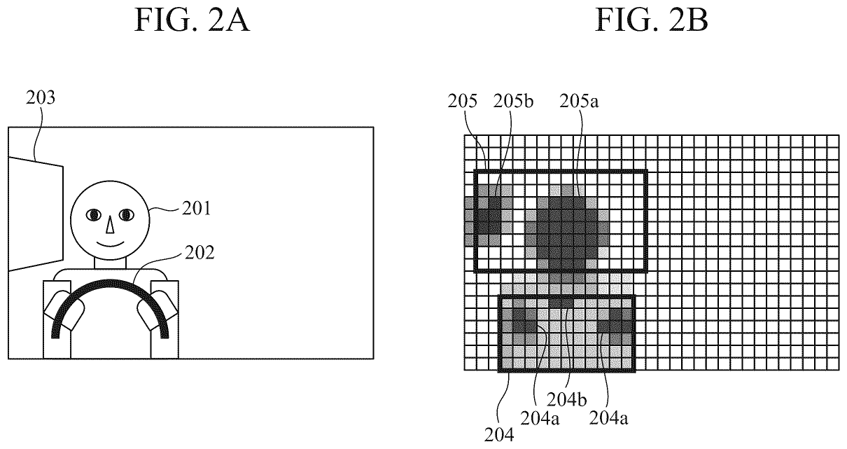

Here, FIG. 2 is a diagram schematically illustrating a concept when the sensor 1 images a vehicle interior and thereby obtains a temperature image in the first embodiment.

FIG. 2A is a diagram for explaining a concept of a situation in the vehicle interior in the imaging region of the sensor 1, and FIG. 2B is a diagram for explaining a concept of a temperature image imaged by the sensor 1 under the situation illustrated in FIG. 2A.

Note that, in FIG. 2A, the sensor 1 is disposed at a position where the sensor 1 images a driver 201 driving the vehicle from the front, but the disposition position of the sensor 1 is not limited thereto. The sensor 1 only needs to be disposed at a position where the sensor 1 can image the hand or the face of the occupant in the vehicle interior.

Here, as illustrated in FIG. 2A, there is the driver 201 gripping a steering wheel 202 in the vehicle interior. There is also a window 203 in the imaging region of the sensor 1.

In the temperature image illustrated in FIG. 2B, each square indicates a pixel, and a color density schematically indicates the height of a temperature. Note that, in FIG. 2B, the darker the color of a pixel, the higher the temperature.

The occupant temperature estimating device 2 estimates the temperatures of the hand and the face of the occupant on the basis of the temperature image as illustrated in FIG. 2B.

In the first embodiment, regions to be subjected to estimation of the temperatures of the hand and the face of the occupant in a region of the temperature image are set in advance. In the following first embodiment, a region to be subjected to estimation of the temperature of the hand of the occupant on the temperature image is referred to as “hand target region”. A region to be subjected to estimation of the face of the occupant on the temperature image is referred to as “face target region”.

The hand target region is set in advance depending on the disposition position and the angle of view of the sensor 1. The hand target region is, for example, a region set by assuming that a hand of a driver of a standard physique will be imaged when the driver sits at a standard position and drives in a temperature image imaged by the sensor 1.

The face target region is set in advance depending on the disposition position and the angle of view of the sensor 1. The face target region is, for example, a region set by assuming that a face of a driver of a standard physique will be imaged when the driver sits at a standard position and drives in a temperature image imaged by the sensor 1. In the first embodiment, the hand target region and the face target region are also collectively referred to simply as “target region”. Note that the target region has a form of a temperature image, and each pixel in the target region has temperature information.

In FIG. 2B, the hand target region is indicated by a reference sign 204, and the face target region is indicated by a reference sign 205.

In the temperature image, a region where the hand of the driver 201 is imaged and a region where the face of the driver 201 is imaged have high temperatures.

Therefore, by extracting a high temperature region from each of the hand target region 204 and the face target region 205, the occupant temperature estimating device 2 can estimate that the temperature of the hand or the face of the driver 201 is the temperature of the extracted high temperature region.

However, there is a heat source other than the hand or the face of the driver 201 in the vehicle interior. In the temperature image, a high temperature region due to the heat source other than the hand or the face of the driver 201 is generated.

For example, when the driver 201 changes the position where the steering wheel 202 is gripped, the steering wheel 202 at a portion which has been gripped by the driver 201 until immediately before the change may have heat. In this case, as illustrated in FIG. 2B, in the hand target region 204 on the temperature image, because of presence of a heat source (second heat source 204b) due to heat remaining in the steering wheel 202 in addition to a heat source (first heat source 204a) due to the hand of the driver 201, a high temperature region due to the first heat source 204a and a high temperature region due to the second heat source 204b are generated.

For example, when the window 203 is heated by sunlight or the like and is hot, as illustrated in FIG. 2B, in the face target region 205 on the temperature image, because of presence of a heat source (fourth heat source 205b) due to heat of the window 203 in addition to a heat source (third heat source 205a) due to the face of the driver 201, a high temperature region due to the third heat source 205a and a high temperature region due to the fourth heat source 205b are generated.

As described above, presence of a heat source serving as noise, such as the second heat source 204b or the fourth heat source 205b, in the hand target region and the face target region may generate a high temperature region.

In this case, if the occupant temperature estimating device 2 simply extracts the temperature of the high temperature region in the target region and estimates that the temperature of the hand or the face of the occupant is the extracted temperature, the occupant temperature estimating device 2 may erroneously estimate the temperature of an erroneous portion that is not the hand of the occupant as the temperature of the hand of the occupant, or may erroneously estimate the temperature of an erroneous portion that is not the face of the occupant as the temperature of the face of the occupant.

In the conventional technique as described above, since it is not considered that a high temperature region due to a heat source other than the body part of the occupant may be generated on the temperature image, the temperature of the body part of the occupant may be erroneously estimated.

In particular, when the resolution of the temperature image is not high, for example, medium or less, it is difficult to distinguish the body part of the occupant from other parts on the temperature image. Therefore, when the temperature of the high temperature region in the target region is simply extracted from the temperature image and thereby the temperature of the body part of the occupant is estimated, there is a high possibility that the temperature of the body part of the occupant may be erroneously estimated.

Meanwhile, by estimating the temperatures of the hand and the face of the occupant from the temperature image in consideration of a possibility of generation of a high temperature region due to a heat source other than the hand and the face of the occupant on the temperature image, the occupant temperature estimating device 2 according to the first embodiment prevents erroneous estimation of the temperatures of the hand and the face of the occupant, and more accurately estimates the temperatures of the hand and the face of the occupant from the temperature image.

The occupant temperature estimating device 2 will be described in detail.

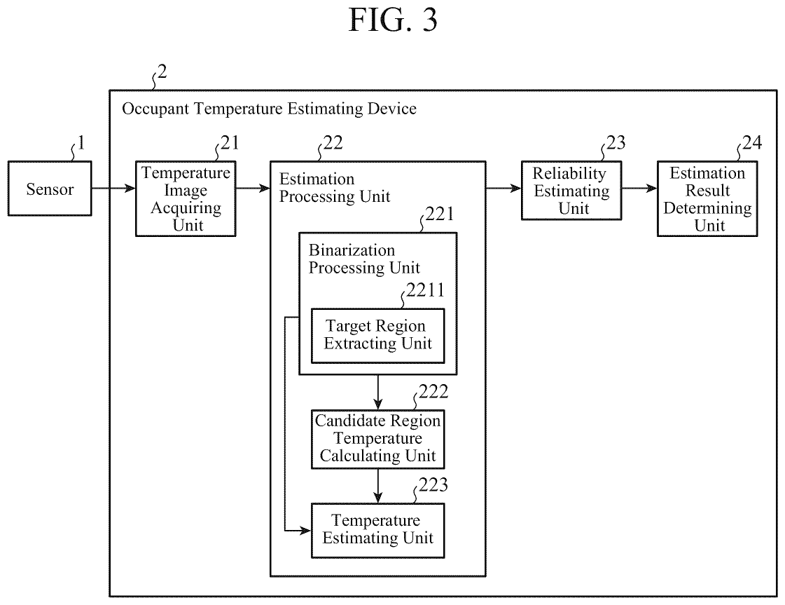

FIG. 3 is a diagram illustrating a configuration example of the occupant temperature estimating device 2 according to the first embodiment.

The occupant temperature estimating device 2 includes a temperature image acquiring unit 21, an estimation processing unit 22, a reliability estimating unit 23, and an estimation result determining unit 24.

The estimation processing unit 22 includes a binarization processing unit 221, a candidate region temperature calculating unit 222, and a temperature estimating unit 223.

The binarization processing unit 221 includes a target region extracting unit 2211.

The temperature image acquiring unit 21 acquires a temperature image from the sensor 1. As described above, the temperature image is a temperature image obtained by imaging a vehicle interior by the sensor 1, and is a temperature image in which each pixel has temperature information.

The temperature image acquiring unit 21 outputs the acquired temperature image to the estimation processing unit 22.

The estimation processing unit 22 estimates the temperatures of the hand and the face of the occupant on the basis of the temperature image acquired by the temperature image acquiring unit 21.

By binarizing pixels in a target region in a region of the temperature image acquired by the temperature image acquiring unit 21, in other words, in the hand target region and the face target region on the basis of temperature information possessed by the pixels, the binarization processing unit 221 of the estimation processing unit 22 sets one or more temperature candidate regions out of the target region. The temperature candidate region is a region within the target region and is a candidate region whose temperature is estimated to be the temperature of the hand of the occupant or the temperature of the face of the occupant.

In the first embodiment, processing of setting one or more temperature candidate regions in the target region by binarizing pixels on the basis of temperature information possessed by the pixels in the target region, performed by the binarization processing unit 221, is also referred to as “binarization processing”.

The binarization processing unit 221 will be described in detail.

First, the target region extracting unit 2211 of the binarization processing unit 221 extracts a target region from the region of the temperature image acquired by the temperature image acquiring unit 21. Specifically, the target region extracting unit 2211 extracts the hand target region and the face target region out of the region of the temperature image.

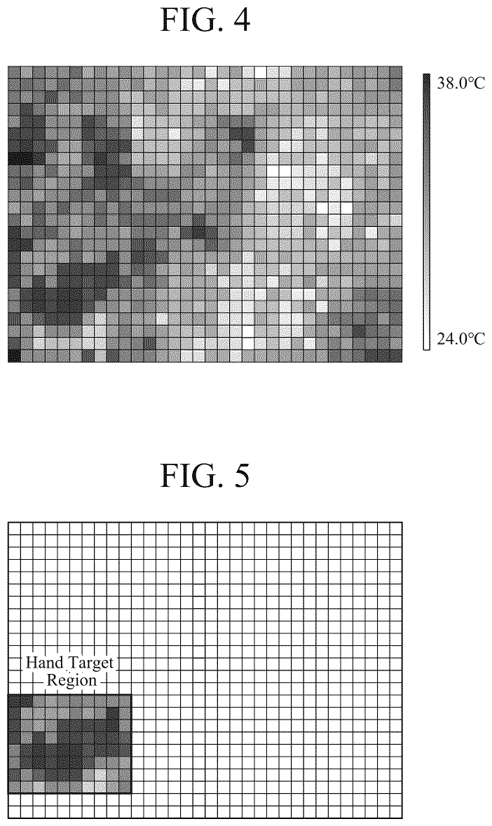

Here, FIGS. 4 and 5 are diagrams for explaining an example of a concept in which the target region extracting unit 2211 extracts the target region out of the region of the temperature image.

FIG. 4 illustrates an example of a concept of the temperature image acquired by the temperature image acquiring unit 21, and FIG. 5 illustrates an example of a concept of the target region extracted by the target region extracting unit 2211 from the temperature image illustrated in FIG. 4. Note that FIGS. 4 and 5 illustrate, as an example, a concept when the target region extracting unit 2211 extracts the hand target region. The target region extracting unit 2211 also extracts the face target region.

In the temperature image illustrated in FIG. 4, each square indicates a pixel, and a color density indicates the height of a temperature. Note that, in FIG. 4, the darker the color of a pixel, the higher the temperature.

The binarization processing unit 221 performs binarization processing on the target region extracted by the target region extracting unit 2211.

Details of the binarization processing by the binarization processing unit 221 will be described below.

First, on the basis of the target region extracted by the target region extracting unit 2211, the binarization processing unit 221 creates an image (hereinafter, referred to as “first binary image”) in which pixels in the target region are classified into a high temperature region and a low temperature region.

Specifically, the binarization processing unit 221 performs Otsu's binarization on the target region (first Otsu's binarization). Since Otsu's binarization is a known image processing technique, a detailed description thereof is omitted.

By performing first Otsu's binarization on the target region, the binarization processing unit 221 classifies pixels in the target region into the high temperature region and the low temperature region depending on whether or not a temperature corresponding to a pixel is equal to or higher than a threshold (hereinafter, referred to as “temperature determination threshold”), and thereby creates a first binary image.

The binarization processing unit 221 classifies pixels whose corresponding temperatures are equal to or higher than the temperature determination threshold into the high temperature region, and classifies pixels whose corresponding temperatures are lower than the temperature determination threshold into the low temperature region.

Here, the high temperature region and the low temperature region classified by first Otsu's binarization are referred to as “first high temperature region” and “first low temperature region”, respectively.

A pixel classified into the first high temperature region by performing first Otsu's binarization by the binarization processing unit 221 is referred to as “class 1 (first)”. A pixel classified into the first low temperature region by performing first Otsu's binarization by the binarization processing unit 221 is referred to as “class 0 (first)”.

The binarization processing unit 221 sets a pixel value of class 1 (first) to “1”, and sets a pixel value of class 0 (first) to “0” in the created first binary image.

The binarization processing unit 221 further masks the region of the pixel classified into “class 0 (first)” in first Otsu's binarization in the target region, in other words, the region of the pixel in the first low temperature region, and performs Otsu's binarization (second Otsu's binarization) on the region of the pixel classified into “class 1 (first)”, in other words, the first high temperature region.

By performing second Otsu's binarization on the first high temperature region in the target region, the binarization processing unit 221 creates an image (hereinafter, referred to as “second binary image”) in which pixels in the first high temperature region are classified into a high temperature region and a low temperature region depending on whether or not a temperature corresponding to a pixel is equal to or higher than a temperature determination threshold. Note that the temperature determination threshold in first Otsu's binarization and the temperature determination threshold in second Otsu's binarization are different from each other.

Specifically, the binarization processing unit 221 classifies pixels whose corresponding temperatures are equal to or higher than the temperature determination threshold into a second high temperature region, and classifies pixels whose corresponding temperatures are lower than the temperature determination threshold into a second low temperature region. Here, the binarization processing unit 221 also classifies the masked pixel in the first low temperature region among pixels in the target region into the low temperature region.

The high temperature region and the low temperature region classified by second Otsu's binarization are referred to as “second high temperature region” and “second low temperature region”, respectively.

A pixel classified into the second high temperature region by performing second Otsu's binarization by the binarization processing unit 221 is referred to as “class 1 (second)”. A pixel classified into the second low temperature region by performing second Otsu's binarization by the binarization processing unit 221 is referred to as “class 0 (second)”.

The binarization processing unit 221 sets a pixel value of class 1 (second) to “1”, and sets a pixel value of class 0 (second) to “0” in the created second binary image.

When the second binary image is created by performing Otsu's binarization on the target region twice as described above, the binarization processing unit 221 groups consecutive pixels of class 1 (second), in other words, adjacent pixels of class 1 (second) in the second binary image, and thereby sets one region. Specifically, when a certain pixel (hereinafter, referred to as “pixel of interest”) among pixels of class 1 (second) is set as a center and there is a pixel of class 1 (second) (hereinafter, referred to as “connected pixel”) in four neighboring pixels that are in vertical and horizontal contact with the pixel of interest, the binarization processing unit 221 groups the pixels by connecting the connected pixel to the pixel of interest. In the first embodiment, a method of connecting a connected pixel of class 1 (second) among four neighboring pixels that are in vertical and horizontal contact with the pixel of interest to the pixel of interest and thereby grouping the pixels is referred to as “four-connection”.

The binarization processing unit 221 sets a region formed by connecting the pixel of interest to the connected pixel by four-connection in the second binary image as a temperature candidate region. One or more temperature candidate regions may be set.

The binarization processing unit 221 assigns a region label to the set temperature candidate region. When there is a plurality of temperature candidate regions, the binarization processing unit 221 assigns different region labels to the respective temperature candidate regions.

In the first embodiment, the second binary image after the binarization processing unit 221 sets the temperature candidate region and assigns the region label to the set temperature candidate region is also referred to as “label image”.

The binarization processing unit 221 assigns, for example, a region label of “0” to the second low temperature region on the label image.

Then, the binarization processing unit 221 sets, as a temperature candidate region in the target region, a temperature candidate region within the target region corresponding to the temperature candidate region set on the label image.

A concept of the binarization processing performed by the binarization processing unit 221 will be specifically described with reference to the drawings.

Note that, in the following description, the binarization processing will be described in detail by assuming that, as an example, the binarization processing unit 221 performs the binarization processing on the hand target region. The binarization processing unit 221 also performs the binarization processing on the face target region by a method similar to that performed on the hand target region.

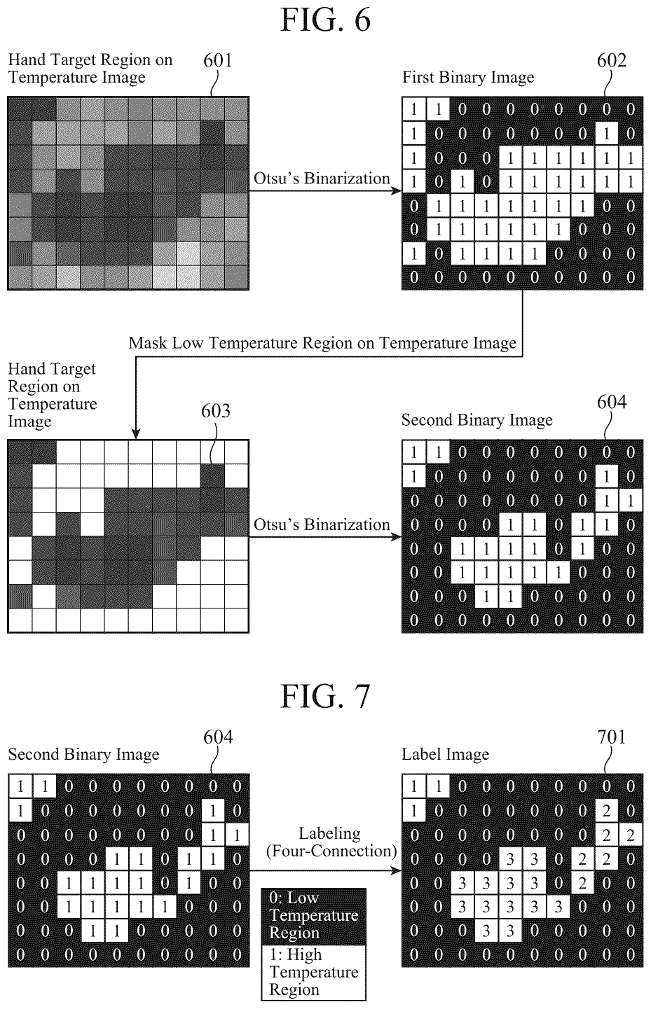

FIG. 6 is a diagram for explaining concepts of first Otsu's binarization and second Otsu's binarization performed by the binarization processing unit 221 in the first embodiment.

Note that FIG. 6 illustrates concepts of first Otsu's binarization and second Otsu's binarization performed by the binarization processing unit 221 on the hand target region extracted by the target region extracting unit 2211. In FIG. 6, as an example, the binarization processing unit 221 performs Otsu's binarization on the hand target region illustrated in FIG. 5.

The binarization processing unit 221 also performs Otsu's binarization on the face target region extracted by the target region extracting unit 2211 by a similar method to Otsu's binarization performed on the hand target region.

First, the binarization processing unit 221 performs first Otsu's binarization on the hand target region (see a reference sign 601 in FIG. 6) extracted by the target region extracting unit 2211.

As a result, the binarization processing unit 221 classifies pixels in the hand target region into the first high temperature region and the first low temperature region depending on whether or not a temperature corresponding to a pixel is equal to or higher than the temperature determination threshold, and thereby creates a first binary image (see a reference sign 602 in FIG. 6).

In the first binary image indicated by a reference sign 602 in FIG. 6, a pixel of class 1 (first) classified into the first high temperature region is indicated by “1”, and a pixel of class 0 (first) classified into the first low temperature region is indicated by “0”.

The binarization processing unit 221 further masks the region of the pixel in the first low temperature region in the hand target region, and then performs second Otsu's binarization on the first high temperature region (see a reference sign 603 in FIG. 6).

As a result, the binarization processing unit 221 creates a second binary image (see a reference sign 604 in FIG. 6) in which pixels in the first high temperature region in the hand target region after the first Otsu's binarization are classified into the second high temperature region and the second low temperature region depending on whether or not a temperature corresponding to a pixel is equal to or higher than the temperature determination threshold. The binarization processing unit 221 also classifies the masked pixel in the first low temperature region into the second low temperature region.

In the second binary image indicated by a reference sign 604 in FIG. 6, a pixel of class 1 (second) classified into the second high temperature region is indicated by “1”, and a pixel of class 0 (second) classified into the second low temperature region is indicated by “0”.

When performing Otsu's binarization twice on the hand target region and thereby creating the second binary image, the binarization processing unit 221 performs four-connection in the second binary image and thereby sets a temperature candidate region. Then, the binarization processing unit 221 assigns a region label to the set temperature candidate region.

FIG. 7 is a diagram for explaining a concept of an example of a label image after the binarization processing unit 221 sets a temperature candidate region and assigns a region label to the set temperature candidate region in the first embodiment.

FIG. 7 illustrates a concept of a label image after the binarization processing unit 221 sets the temperature candidate region in the second binary image indicated by a reference sign 604 in FIG. 6 and assigns a region label to the set temperature candidate region. That is, the binarization processing unit 221 assigns a region label to the temperature candidate region set by grouping pixels of class 1 (second) by performing four-connection.

For example, as illustrated in FIG. 7, the binarization processing unit 221 sets three temperature candidate regions, and assigns region labels of “1” to “3” to the respective temperature candidate regions. For example, as illustrated in FIG. 7, the binarization processing unit 221 assigns, to a pixel in a temperature candidate region, a region label assigned to the temperature candidate region including the pixel (see a reference sign 701 in FIG. 7).

Meanwhile, the binarization processing unit 221 assigns, for example, a region label of “0” to the second low temperature region.

The binarization processing unit 221 sets, as a temperature candidate region in the hand target region, a temperature candidate region within the hand target region corresponding to the temperature candidate region set on the label image.

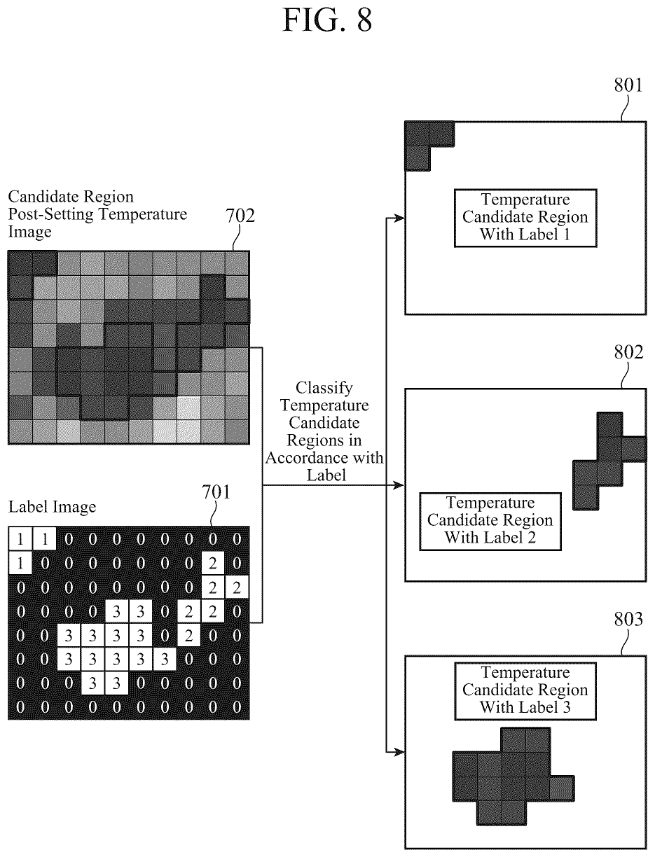

When performing the binarization processing as described above, the binarization processing unit 221 outputs the hand target region after the temperature candidate region is set (hereinafter, referred to as “candidate region post-setting temperature image”, see a reference sign 702 in FIG. 8 described later) and the label image to the candidate region temperature calculating unit 222 and the temperature estimating unit 223 in the estimation processing unit 22.

Return to the description of FIG. 3.

The candidate region temperature calculating unit 222 calculates, on the basis of temperature information possessed by pixels in a temperature candidate region in the target region, a region temperature for the temperature candidate region.

Specifically, first, the candidate region temperature calculating unit 222 classifies, on the basis of the candidate region post-setting temperature image and the label image output from the binarization processing unit 221, temperature candidate regions in the candidate region post-setting temperature image into regions of the respective region labels assigned to the temperature candidate regions.

Then, the candidate region temperature calculating unit 222 calculates region temperatures for the respective temperature candidate regions classified in accordance with the region label.

Specifically, for example, the candidate region temperature calculating unit 222 calculates a median value of the temperature information possessed by the pixels in the temperature candidate region, and uses the calculated median value as the region temperature of the temperature candidate region.

A concept of an example of a method in which the candidate region temperature calculating unit 222 calculates, on the basis of temperature information possessed by pixels in a temperature candidate region in the target region, a region temperature for the temperature candidate region will be described with reference to the drawings.

In the following description, as an example, the candidate region temperature calculating unit 222 calculates the region temperature on the basis of the temperature information possessed by pixels in the temperature candidate region in the hand target region, but the candidate region temperature calculating unit 222 also calculates a region temperature for the face target region by a method similar to the method performed for the hand target region.

FIG. 8 is a diagram for explaining a concept in which the candidate region temperature calculating unit 222 classifies, on the basis of the candidate region post-setting temperature image and the label image, temperature candidate regions in the candidate region post-setting temperature image into regions of the respective region labels assigned to the temperature candidate regions in the first embodiment.

Note that, in FIG. 8, the label image is the label image illustrated in FIG. 7 (see a reference sign 701 in FIG. 7). In FIG. 8, the candidate region post-setting temperature image indicates a candidate region post-setting temperature image in which the binarization processing unit 221 sets a temperature candidate region on the basis of a temperature candidate region set on the label image (see a reference sign 702 in FIG. 8).

Here, as illustrated in FIG. 8, three temperature candidate regions are set, and region labels “1”, “2”, and “3” are assigned to the respective temperature candidate regions in the label image.

The candidate region temperature calculating unit 222 classifies the temperature candidate regions in the candidate region post-setting temperature image into a temperature candidate region with the region label “1” (see a reference sign 801 in FIG. 8), a temperature candidate region with the region label “2” (see a reference sign 802 in FIG. 8), and a temperature candidate region with the region label “3” (see a reference sign 803 in FIG. 8).

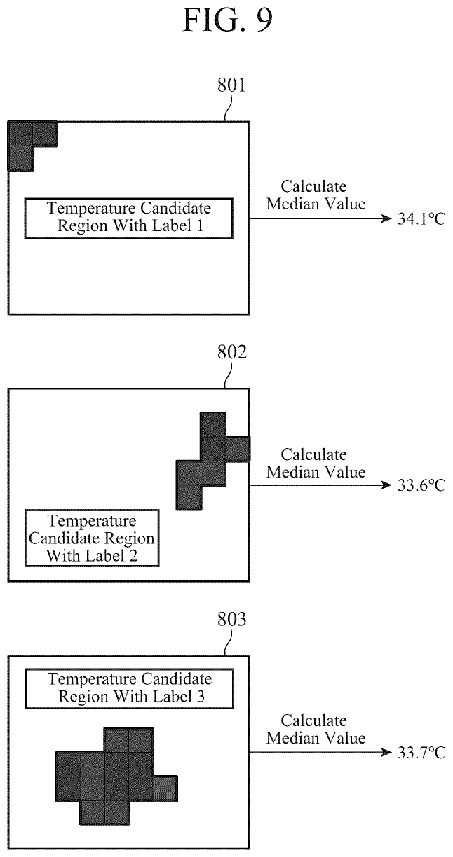

FIG. 9 is a diagram for explaining a concept in which the candidate region temperature calculating unit 222 calculates a region temperature for a classified temperature region in the first embodiment.

Note that FIG. 9 illustrates a concept in which the candidate region temperature calculating unit 222 calculates a region temperature for each of the temperature candidate region with the region label “1”, the temperature candidate region with the region label “2”, and the temperature candidate region with the region label “3” illustrated in FIG. 8.

The candidate region temperature calculating unit 222 calculates a median value of temperature information possessed by pixels in the temperature candidate region with the region label “1”, a median value of temperature information possessed by pixels in the temperature candidate region with the region label “2”, and a median value of temperature information possessed by pixels in the temperature candidate region with the region label “3”.

In FIG. 9, the candidate region temperature calculating unit 222 calculates that the median value of the temperature information possessed by pixels in the temperature candidate region with the region label “1” is 34.1° C., the median value of the temperature information possessed by pixels in the temperature candidate region with the region label “2” is 33.6° C., and the median value of the temperature information possessed by pixels in the temperature candidate region with the region label “3” is 33.7° C.

The candidate region temperature calculating unit 222 sets the region temperature of the temperature candidate region with the region label “1” to 34.1° C., sets the region temperature of the temperature candidate region with the region label “2” to 33.6° C., and sets the region temperature of the temperature candidate region with the region label “3” to 33.7° C.

The candidate region temperature calculating unit 222 outputs information in which the temperature candidate region and the region temperature are associated with each other (hereinafter, referred to as “region temperature information”) to the temperature estimating unit 223 in the estimation processing unit 22.

The temperature estimating unit 223 calculates a separation degree, determines one temperature region from among temperature candidate regions in the target region set by the binarization processing unit 221 on the basis of the calculated separation degree, and estimates that the temperature of the hand or the face of the occupant is the region temperature for the one temperature region.

In the first embodiment, the “separation degree” is a degree indicating how much temperature information possessed by pixels in the temperature candidate region in the target region stands out from temperature information possessed by pixels in a region other than the temperature candidate region in the target region.

The temperature estimating unit 223 first calculates the separation degree on the basis of the following formula (1).

Separation degree (%)=inter-class dispersion(σ_{b}²)=total dispersion(σₜ²) (1)
total dispersion σₜ²
   dispersion of total temperature pixels belonging to class 1 (foreground) and class 2 (background)
inter-class dispersion

$${σ}_{b}^{2} = \frac{{ω}_{1} {{ω}_{2} ( {m}_{1} - {m}_{2} )}^{2}}{{( {ω}_{1} + {ω}_{2} )}^{2}}$$

ω₁ number of pixels belonging to class 1 (foreground)
   ω₂ number of pixels belonging to class 2 (background)
   m₁ average value of pixels belonging to class 1 (foreground)
   m₂ average value of pixels belonging to class 2 (background)
   0≤σ_{b}²≤σₜ² and 0≤σ_{b}²/σₜ²≤1 are satisfied

In the above description, class 1 (foreground) refers to a temperature candidate region in the entire region of the candidate region post-setting temperature image (target region). Class 2 (background) refers to a region other than the temperature candidate region in the candidate region post-setting temperature image (target region).

The temperature estimating unit 223 calculates the separation degree for each temperature candidate region.

The following description will be given, as an example, by assuming that the temperature estimating unit 223 calculates the separation degree for each temperature candidate region for the hand target region. However, the temperature estimating unit 223 also calculates the separation degree for the face target region by a method similar to the method performed for the hand target region.

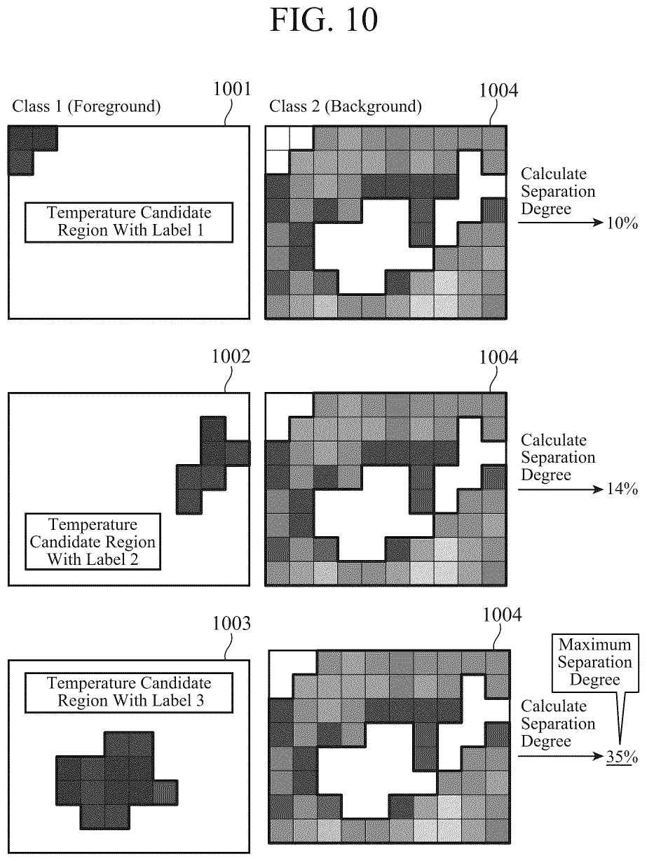

Here, FIG. 10 is a diagram illustrating a concept of an example of calculation of the separation degree by the temperature estimating unit 223 in the first embodiment.

FIG. 10 illustrates a concept in which, when the candidate region post-setting temperature image (see a reference sign 702 in FIG. 8) and the label image (see a reference sign 701 in FIG. 8) as illustrated in FIG. 8 are output from the binarization processing unit 221, the temperature estimating unit 223 calculates the separation degree for each of the temperature candidate regions to which region labels “1” to “3” are assigned.

First, the temperature estimating unit 223 creates class 1 (foreground) for each temperature candidate region to which a region label is assigned on the basis of the candidate region post-setting temperature image and the label image output from the binarization processing unit 221 (see reference signs 1001, 1002, and 1003 in FIG. 10).

Specifically, the temperature estimating unit 223 extracts a temperature candidate region in the candidate region post-setting temperature image in accordance with the region label assigned to the temperature candidate region, and thereby creates class 1 (foreground).

Note that, when performing classification in accordance with the region label assigned to the temperature candidate region in the candidate region post-setting temperature image (see FIG. 8), the candidate region temperature calculating unit 222 may create class 1 (foreground) and output class 1 to the temperature estimating unit 223.

The temperature estimating unit 223 creates class 2 (background).

Specifically, the temperature estimating unit 223 extracts a region other than the temperature candidate region on the basis of the candidate region post-setting temperature image output from the binarization processing unit 221, and thereby creates class 2 (background) (see a reference sign 1004 in FIG. 10).

Then, the temperature estimating unit 223 calculates a separation degree for each temperature candidate region using the above formula (1).

In FIG. 10, the temperature estimating unit 223 calculates a separation degree of 10% for the temperature candidate region to which the region label “1” is assigned, a separation degree of 14% for the temperature candidate region to which the region label “2” is assigned, and a separation degree of 35% for the temperature candidate region to which the region label “3” is assigned.

After calculating the separation degree as described above, the temperature estimating unit 223 determines one temperature region from among the temperature candidate regions on the basis of the calculated separation degree.

For example, the temperature estimating unit 223 determines that a temperature candidate region having the largest calculated separation degree is the temperature region. In the example of FIG. 10, the temperature estimating unit 223 determines that the temperature candidate region to which the region label “3” is assigned is the temperature region. That is, the temperature estimating unit 223 estimates, among the temperature candidate regions, that the temperature candidate region to which the region label “3” is assigned is a high temperature region capturing the temperature of the hand, and that the temperature candidate regions to which the region labels “1” and “2” are assigned are not the high temperature region capturing the temperature of the hand. The temperature estimating unit 223 does not use a temperature candidate region that is estimated not to be a high temperature region capturing the temperature of the hand for estimation of the temperature of the hand.

Then, the temperature estimating unit 223 estimates that the temperature of the hand or the face of the occupant is a region temperature for the determined temperature region.

The temperature estimating unit 223 may determine the region temperature for the determined temperature region from the region temperature information output from the candidate region temperature calculating unit 222.

For example, in the example of FIG. 10, the temperature estimating unit 223 estimates that the temperature of the hand of the occupant is the region temperature 33.7° C. (see FIG. 9) of the determined temperature region (temperature candidate region to which the region label “3” is assigned).

The temperature estimating unit 223 outputs information regarding the estimated temperatures of the hand and the face of the occupant to the reliability estimating unit 23. The information regarding the estimated temperatures of the hand and the face of the occupant includes, in addition to the temperatures of the hand and the face of the occupant estimated by the temperature estimating unit 223, information regarding the temperature region in the target region and a calculated separation degree of the temperature region.

The reliability estimating unit 23 estimates a reliability of the temperatures of the hand and the face of the occupant estimated by the temperature estimating unit 223 on the basis of the information regarding the temperatures of the hand and the face of the occupant estimated by the temperature estimating unit 223.

For example, the reliability estimating unit 23 estimates the reliability using a learned model in machine learning (hereinafter, referred to as “machine learning model”).

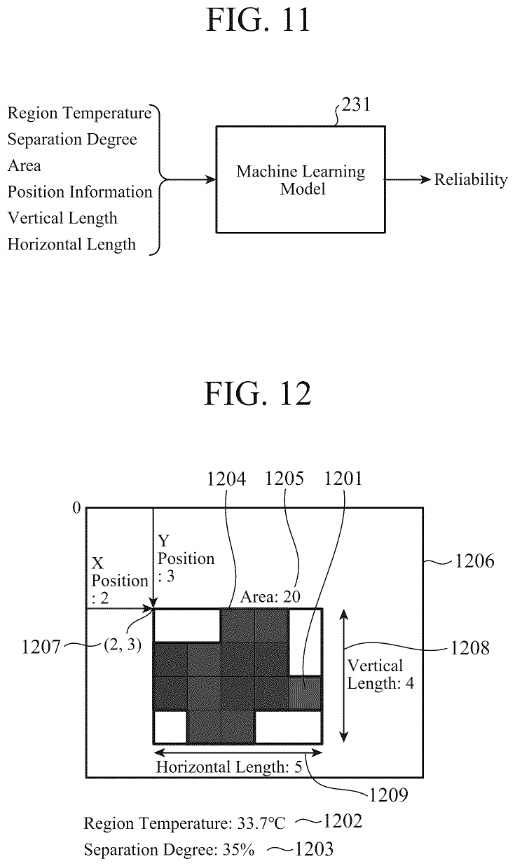

FIG. 11 is a diagram for explaining a concept of a machine learning model 231 used when the reliability estimating unit 23 estimates a reliability in the first embodiment.

The machine learning model 231 is a learned model that receives, as inputs, the region temperature of the temperature region, the separation degree of the temperature region, the area of a circumscribed rectangle circumscribing the temperature region in the target region, position information of the circumscribed rectangle in the target region, the vertical length of the circumscribed rectangle, and the horizontal length of the circumscribed rectangle, and outputs a reliability. The reliability is represented by, for example, a numerical value of 0 to 1.

The machine learning model 231 corresponding to the hand of the occupant and the machine learning model 231 corresponding to the face of the occupant are created in advance. The machine learning model 231 is constituted by, for example, a Bayesian model or a neural network.

FIG. 12 is a diagram for explaining information to be an input to the machine learning model 231 in detail in the first embodiment.

FIG. 12 illustrates the region temperature of the temperature region (see a reference sign 1202 in FIG. 12), the separation degree thereof (see a reference sign 1203 in FIG. 12), the area (see a reference sign 1205 in FIG. 12) of a circumscribed rectangle (see a reference sign 1204 in FIG. 12) in the target region (see a reference sign 1206 in FIG. 12), position information of the circumscribed rectangle (see a reference sign 1207 in FIG. 12) in the target region, the vertical length of the circumscribed rectangle (see a reference sign 1208 in FIG. 12), and the horizontal length of the circumscribed rectangle (see a reference sign 1209 in FIG. 12) when the temperature region is a region indicated by a reference sign 1201.

In the first embodiment, the position of the circumscribed rectangle is the position of a point at an upper left end of the circumscribed rectangle on the target region when an upper left of the target region is used as an origin. The position of the circumscribed rectangle is represented by the coordinates of the position of the point at the upper left end of the circumscribed rectangle. The position information of the circumscribed rectangle includes the X coordinate and the Y coordinate of the point at the upper left end of the circumscribed rectangle.

The machine learning model 231 is created in advance by, for example, a learning device (not illustrated).

The learning device acquires, for example, a temperature image imaged when the vehicle is experimentally caused to travel and the temperatures of the hand and the face of the occupant estimated by the occupant temperature estimating device 2 mounted on the vehicle. Then, from the temperature image acquired at the time of the experiment, the region temperature, the separation degree, the area of the circumscribed rectangle, the position information of the circumscribed rectangle, the vertical length of the circumscribed rectangle, and the horizontal length of the circumscribed rectangle are calculated. Note that the region temperature is the temperature of the hand or the face of the occupant estimated by the occupant temperature estimating device 2 at the time of the experiment. In addition, the learning device calculates an error between the temperature of the hand of the occupant acquired at the time of the experiment and the actual temperature of the hand of the occupant at the time of the experiment, and an error between the temperature of the face of the occupant acquired at the time of the experiment and the actual temperature of the face of the occupant at the time of the experiment. Note that the actual temperatures of the hand and the face of the occupant are manually input by, for example, an administrator or the like. The learning device uses the calculated error as teacher data.

The learning device causes the machine learning model 231 to perform learning by so-called supervised learning using the acquired region temperature, the acquired separation degree, the acquired area of the circumscribed rectangle, the acquired position information of the circumscribed rectangle, the acquired vertical length of the circumscribed rectangle, the acquired horizontal length of the circumscribed rectangle, and the errors as learning data.

Here, it is assumed that the reliability estimating unit 23 estimates the reliability of the temperature of the hand of the occupant estimated by the temperature estimating unit 223. At this time, the reliability estimating unit 23 uses, as inputs to the machine learning model 231 for estimating the reliability of the temperature of the hand of the occupant, the temperature of the hand of the occupant estimated by the temperature estimating unit 223, in other words, the region temperature of the temperature region determined by the temperature estimating unit 223, the separation degree of the temperature region calculated by the temperature estimating unit 223, the area of the circumscribed rectangle circumscribing the temperature region in the target region, the position information of the circumscribed rectangle in the target region, the vertical length of the circumscribed rectangle, and the horizontal length of the circumscribed rectangle, and then uses the obtained reliability as the reliability of the temperature of the hand of the occupant estimated by the temperature estimating unit 223.

In the first embodiment, the reliability estimating unit 23 may estimate the reliability of the temperatures of the hand and the face of the occupant estimated by the temperature estimating unit 223 in accordance with a calculation rule set in advance.

The calculation rule is set in advance. The calculation rule can be set appropriately, but a calculation rule based on the region temperature of the temperature region, the separation degree of the temperature region, the area of the circumscribed rectangle circumscribing the temperature region in the target region, the position information of the circumscribed rectangle in the target region, the vertical length of the circumscribed rectangle, and the horizontal length of the circumscribed rectangle is used.

Specifically, the calculation rule has, for example, the following contents.

<Calculation Rule>

The reliability is a result obtained by integrating an evaluation value of the region temperature of the temperature region (first evaluation value), an evaluation value of the separation degree of the temperature region (second evaluation value), an evaluation value of the area of the circumscribed rectangle circumscribing the temperature region in the target region (third evaluation value), an evaluation value of the position information of the circumscribed rectangle in the target region (fourth evaluation value), an evaluation value of the vertical length of the circumscribed rectangle (fifth evaluation value), and the horizontal length of the circumscribed rectangle (sixth evaluation value).

The first evaluation value to the sixth evaluation value are calculated, for example, as follows.

First evaluation value: calculated to be “1” when the region temperature of the temperature region is equal to or higher than a threshold (first threshold), and calculated to be “0.5” when the region temperature is lower than the first threshold

Second evaluation value: calculated to be “1” when the separation degree of the temperature region is equal to or higher than a threshold (second threshold), and calculated to be “0.5” when the separation degree is lower than the second threshold

Third evaluation value: calculated to be “1” when the area of the circumscribed rectangle is equal to or higher than a threshold (third threshold), and calculated to be “0.5” when the area of the circumscribed rectangle is lower than the third threshold

Fourth evaluation value: calculated to be “1” when the position of the circumscribed rectangle is within a predetermined region, and calculated to be “0.5” when the position of the circumscribed rectangle is not within the predetermined region

Fifth evaluation value: calculated to be “1” when the vertical length of the circumscribed rectangle is equal to or higher than a threshold (fifth threshold), and calculated to be “0.5” when the vertical length of the circumscribed rectangle is lower than the fifth threshold

Sixth evaluation value: calculated to be “1” when the horizontal length of the circumscribed rectangle is equal to or higher than a threshold (sixth threshold), and calculated to be “0.5” when the horizontal length of the circumscribed rectangle is lower than the sixth threshold

The reliability estimating unit 23 outputs information regarding the estimated reliability to the estimation result determining unit 24. The reliability estimating unit 23 outputs the information regarding the temperatures of the hand and the face estimated by the temperature estimating unit 223 to the estimation result determining unit 24 in association with the estimated reliability.

The estimation result determining unit 24 determines whether or not to adopt the temperatures of the hand and the face of the occupant estimated by the temperature estimating unit 223 by comparing the reliability estimated by the reliability estimating unit 23 with a threshold set in advance (hereinafter, referred to as “reliability determination threshold”).

For example, when the reliability is equal to or higher than the reliability determination threshold, the estimation result determining unit 24 determines that the temperatures of the hand and the face of the occupant estimated by the temperature estimating unit 223 are reliable, and outputs information regarding the temperatures of the hand and the face of the occupant.

Note that the reliability determination thresholds set for the hand of the occupant and the face of the occupant may be different from each other.

For example, when determining that only one of the temperature of the hand of the occupant and the temperature of the face of the occupant is reliable, the estimation result determining unit 24 may output only the information regarding the temperature determined to be reliable. In addition, for example, when determining that at least one of the temperature of the hand of the occupant and the temperature of the face of the occupant is unreliable, the estimation result determining unit 24 may determine that neither the temperature of the hand of the occupant nor the temperature of the face of the occupant is reliable, and the estimation result determining unit 24 may determine not to output information regarding either of the temperatures.

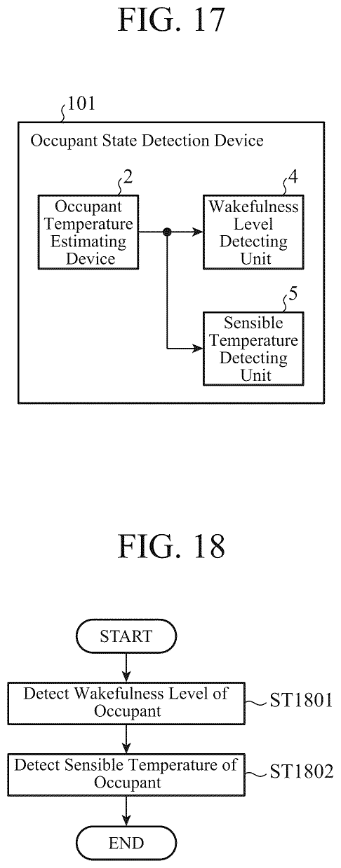

Examples of an output destination of the information regarding the temperatures of the hand and the face of the occupant by the estimation result determining unit 24 include a wakefulness level detecting unit 4 and a sensible temperature detecting unit 5 (see FIG. 17) described later. Note that this is merely an example, and the output destination of the information regarding the temperatures of the hand and the face of the occupant by the estimation result determining unit 24 may be another device.

For example, the estimation result determining unit 24 may store information regarding the temperature of the hand or the face of the occupant determined to be reliable in a storage unit (not illustrated).

An operation of the occupant temperature estimating device 2 according to the first embodiment will be described.

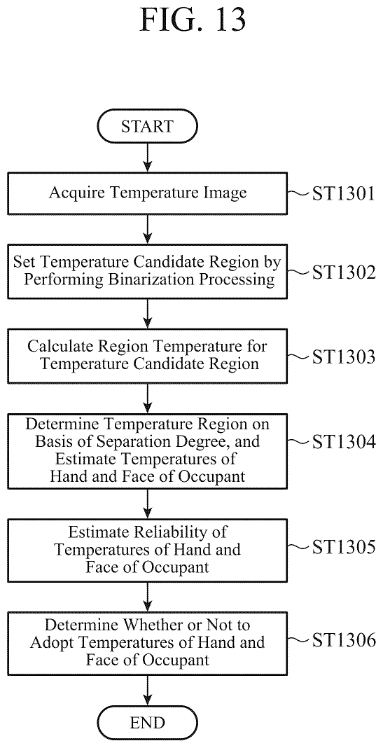

FIG. 13 is a flowchart for explaining the operation of the occupant temperature estimating device 2 according to the first embodiment.

The temperature image acquiring unit 21 acquires a temperature image from the sensor 1 (step ST1301).

The temperature image acquiring unit 21 outputs the acquired temperature image to the estimation processing unit 22.

The binarization processing unit 221 of the estimation processing unit 22 sets one or more temperature candidate regions in the target region by binarizing pixels in the target region in the region of the temperature image acquired by the temperature image acquiring unit 21 in step ST1301, in other words, in the hand target region and the face target region on the basis of temperature information possessed by the pixels (step ST1302).

The binarization processing unit 221 outputs the candidate region post-setting temperature image of the target region after the temperature candidate region is set and the label image to the candidate region temperature calculating unit 222 and the temperature estimating unit 223 in the estimation processing unit 22.

The candidate region temperature calculating unit 222 calculates, on the basis of temperature information possessed by pixels in a temperature candidate region in the target region, a region temperature for the temperature candidate region (step ST1303).

The candidate region temperature calculating unit 222 outputs region temperature information in which the temperature candidate region and the region temperature are associated with each other to the temperature estimating unit 223 in the estimation processing unit 22.

The temperature estimating unit 223 calculates a separation degree, determines one temperature region from among temperature candidate regions set by the binarization processing unit 221 in step ST1302 on the basis of the calculated separation degree, and estimates that the temperature of the hand or the face of the occupant is a region temperature for the one temperature region (step ST1304).

The temperature estimating unit 223 outputs information regarding the estimated temperatures of the hand and the face of the occupant to the reliability estimating unit 23.

The reliability estimating unit 23 estimates a reliability of the temperatures of the hand and the face of the occupant estimated by the temperature estimating unit 223 on the basis of the information regarding the temperatures of the hand and the face of the occupant estimated by the temperature estimating unit 223 in step ST1304 (step ST1305).

The reliability estimating unit 23 outputs information regarding the estimated reliability to the estimation result determining unit 24. The reliability estimating unit 23 outputs the information regarding the temperatures of the hand and the face estimated by the temperature estimating unit 223 to the estimation result determining unit 24 in association with the estimated reliability.

The estimation result determining unit 24 determines whether or not to adopt the temperatures of the hand and the face of the occupant estimated by the temperature estimating unit 223 by comparing the reliability estimated by the reliability estimating unit 23 in step ST1305 with the reliability determination threshold (step ST1306).

When determining to adopt the temperatures of the hand and the face of the occupant estimated by the temperature estimating unit 223, the estimation result determining unit 24 outputs the information regarding the temperatures of the hand and the face of the occupant.

As described above, the occupant temperature estimating device 2 according to the first embodiment sets a temperature candidate region in the target region by binarizing pixels in the target region in the region of the acquired temperature image on the basis of temperature information possessed by the pixels, and calculates a region temperature for the temperature candidate region. Then, the occupant temperature estimating device 2 determines a temperature region from among the temperature candidate regions on the basis of the separation degrees calculated for the temperature candidate regions in the target region, and estimates that the temperature of the hand or the face of the occupant is the region temperature for the determined temperature region.

As a result, the occupant temperature estimating device 2 can enhance estimation accuracy of the temperatures of the hand and the face of the occupant based on the temperature image as compared with a conventional temperature estimating technique based on the temperature image.

In addition, the occupant temperature estimating device 2 can accurately estimate the temperatures of the hand and the face of the occupant even from a temperature image having a medium or lower resolution. Therefore, the occupant temperature estimating system 100 can make the sensor 1 used to estimate the temperatures of the hand and the face of the occupant relatively inexpensive. In addition, in the occupant temperature estimating system 100, for example, it is not necessary to newly dispose a highly accurate sensor in order to enhance the estimation accuracy of the temperatures of the hand and the face of the occupant, and for example, it is possible to accurately estimate the temperatures of the hand and the face of the occupant by using an existing sensor having a medium or lower resolution, such as a sensor used in a driver monitoring system.

In addition, the occupant temperature estimating device 2 according to the first embodiment estimates the reliability of the estimated temperatures of the hand and the face of the occupant, and determines whether or not to adopt the estimated temperatures of the hand and the face of the occupant by comparing the estimated reliability with the reliability determination threshold.

Therefore, the occupant temperature estimating device 2 can further enhance the estimation accuracy of the temperatures of the hand and the face of the occupant based on the temperature image, and can prevent an estimation result with low reliability among the estimation results of the temperatures of the hand and the face of the occupant from being used in another device or the like.

In the first embodiment described above, the occupant temperature estimating device 2 can determine whether or not the estimated temperatures of the hand and the face of the occupant are reliable in consideration of the situation of the occupant determined on the basis of a camera image imaged by a camera, which will be described in detail below.

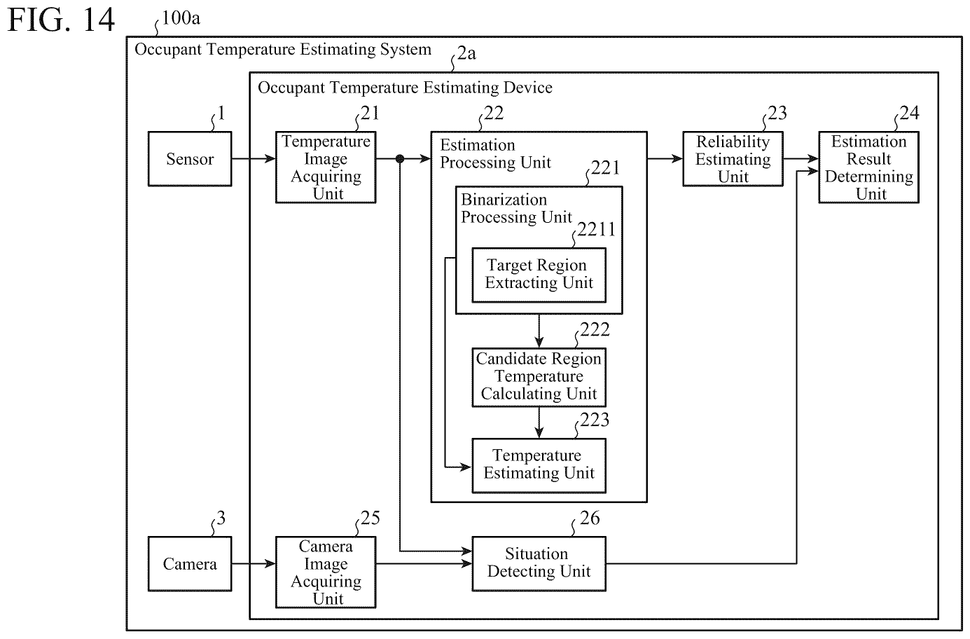

FIG. 14 is a diagram illustrating a configuration example of an occupant temperature estimating device 2a that determines whether or not the estimated temperatures of the hand and the face of the occupant are reliable in consideration of a situation of the occupant, and a configuration example of an occupant temperature estimating system 100a including the occupant temperature estimating device 2a in the first embodiment.

In FIG. 14, similar components to those of the occupant temperature estimating system 100 described with reference to FIG. 1 and similar components to those of the occupant temperature estimating device 2 described with reference to FIG. 3 are denoted by the same reference signs, and redundant description is omitted.

The occupant temperature estimating system 100a includes a camera 3.

The camera 3 is, for example, a visible light camera or an infrared camera, and is mounted on a vehicle. The camera 3 images a vehicle interior and thereby acquires a camera image. The camera 3 is disposed at a position where the camera 3 can image a region of a hand or a face of an occupant in the vehicle interior. That is, an imaging region of the camera 3 includes a region including the face or the hand of the occupant. Note that the imaging regions of the camera 3 and the sensor 1 do not have to be the same as each other. The camera 3 may be shared with a so-called driver monitoring system.

The camera 3 outputs the camera image to the occupant temperature estimating device 2a.

The occupant temperature estimating device 2a is different from the occupant temperature estimating device 2 in that the occupant temperature estimating device 2a includes a camera image acquiring unit 25 and a situation detecting unit 26.

The camera image acquiring unit 25 acquires a camera image obtained by imaging the occupant in the vehicle interior by the camera 3.

The camera image acquiring unit 25 outputs the acquired camera image to the situation detecting unit 26.

The situation detecting unit 26 detects the situation of the occupant on the basis of the camera image acquired by the camera image acquiring unit 25. In the first embodiment, the situation of the occupant detected by the situation detecting unit 26 is a situation that is assumed to hinder detection of the temperatures of the hand and the face of the occupant.

Specifically, for example, the situation detecting unit 26 detects a region of the occupant's hair or a face direction angle of the occupant in the temperature image acquired by the temperature image acquiring unit 21 on the basis of a region of the occupant's hair or a face direction angle of the occupant in the camera image acquired by the camera image acquiring unit 25.

Note that in the occupant temperature estimating device 2a, the temperature image acquiring unit 21 outputs the temperature image to the estimation processing unit 22 and the situation detecting unit 26.

The situation detecting unit 26 may detect the region of the occupant's hair or the face direction angle of the occupant in the camera image using a known image processing technique.

The disposition position and the angle of view of the camera 3 and the disposition position and the angle of view of the sensor 1 are known in advance. Therefore, when detecting the region of the occupant's hair in the camera image or the face direction angle of the occupant with respect to the camera 3, the situation detecting unit 26 can detect the region of the occupant's hair in the temperature image or the face direction angle of the occupant with respect to the sensor 1. Note that, as the face direction angle of the occupant with respect to the sensor 1 is larger, it is further assumed that the face of the occupant is not directed to the sensor 1, in other words, detection of the temperature of the face of the occupant is hindered.

The situation detecting unit 26 outputs information regarding the detected situation of the occupant, specifically, for example, information regarding the region of the occupant's hair in the temperature image or information regarding the face direction angle of the occupant to the estimation result determining unit 24.

When the region of the occupant's hair detected by the situation detecting unit 26 is equal to or higher than a threshold set in advance (hereinafter, referred to as “hair region determination threshold”), or when the face direction angle of the occupant detected by the situation detecting unit 26 is equal to or higher than a threshold set in advance (hereinafter, referred to as “face direction angle determination threshold”), the estimation result determining unit 24 does not adopt the temperature of the face of the occupant estimated by the temperature estimating unit 223.

As the hair region determination threshold, a size of a region is set to such an extent that the temperature of the face is not sufficiently detected in the temperature image. In addition, as the face direction angle determination threshold, a face direction angle is set to such an extent that the temperature of the face is not sufficiently detected in the temperature image.

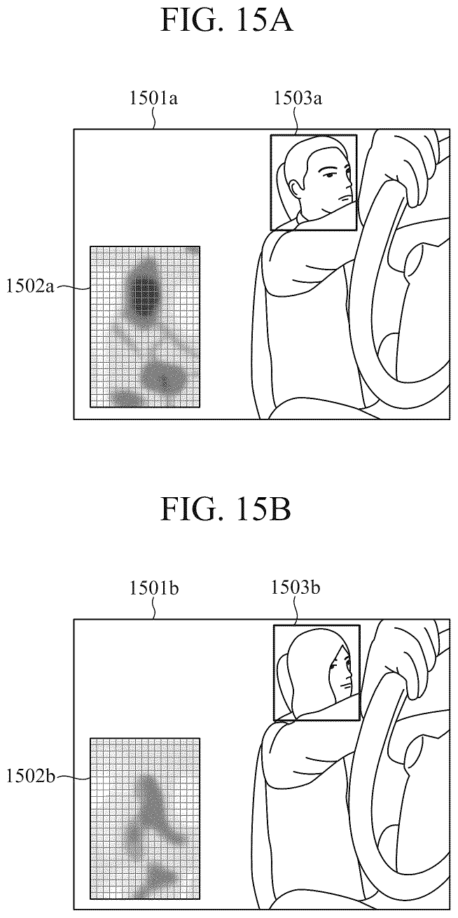

FIGS. 15A and 15B are diagrams for explaining concepts of examples of situations of an occupant when the estimation result determining unit 24 determines to adopt the temperature of the face of the occupant estimated by the temperature estimating unit 223 and when the estimation result determining unit 24 determines not to adopt the temperature of the face of the occupant estimated by the temperature estimating unit 223, respectively.

Note that FIG. 15A illustrates a concept of an example of a case where the estimation result determining unit 24 determines to adopt the temperature of the face of the occupant estimated by the temperature estimating unit 223, and FIG. 15B illustrates a concept of an example of a case where the estimation result determining unit 24 determines not to adopt the temperature of the face of the occupant estimated by the temperature estimating unit 223.

FIG. 15A illustrates an example of a concept of a camera image 1501a imaged by the camera 3. For convenience of explanation, a temperature image 1502a imaged by the sensor 1 in the same situation as the situation in the vehicle interior when the camera 3 images the camera image 1501a is superimposed on the camera image 1501a.

FIG. 15B illustrates an example of a concept of another camera image 1501b imaged by the camera 3. For convenience of explanation, a temperature image 1502b imaged by the sensor 1 in the same situation as the situation in the vehicle interior when the camera 3 images the camera image 1501b is superimposed on the camera image 1501a.

In the camera image 1501a illustrated in FIG. 15A, there are few portions where the occupant's hair covers the face (see a reference sign 1503a in FIG. 15A). In the temperature image 1502a, it can be seen that the face portion of the occupant has a high temperature and thus the temperature of the face is captured.

Meanwhile, in the camera image 1501b illustrated in FIG. 15B, most of the face of the occupant is hidden by the occupant's hair (see a reference sign 1503b in FIG. 15B). In the temperature image 1502b, the temperature of the face portion of the occupant is not captured.

As described above, for example, when most of the face of the occupant is hidden by the occupant's hair, the temperature of the face portion of the occupant is not detected on the temperature image. Therefore, there is a possibility that the occupant temperature estimating device 2 cannot determine the face region of the occupant as a high temperature region on the basis of the temperature image. That is, the occupant temperature estimating device 2 may erroneously estimate the temperature of the face of the occupant.

Note that FIGS. 15A and 15B described above illustrate an example of a case where the occupant's hair covers the face. However, for example, also when the face of the occupant is directed in a direction different from the direction of the sensor 1, the temperature of the face of the occupant cannot be captured in the temperature image.

Therefore, the occupant temperature estimating device 2a includes the situation detecting unit 26, and the estimation result determining unit 24 does not adopt the temperatures of the hand and the face of the occupant estimated by the temperature estimating unit 223, for example, when the region of the occupant's hair detected by the situation detecting unit 26 is equal to or higher than the hair region determination threshold.

As a result, the occupant temperature estimating device 2a can prevent erroneous estimation of the temperature of the face of the occupant.

Note that, for example, FIGS. 15A and 15B described above illustrate an example of a case where the temperature of the face of the occupant cannot be captured in the temperature image. However, for example, also when the hand of the occupant is covered with an object such as clothes, the temperature of the hand of the occupant cannot be captured in the temperature image. In this case, for example, the situation detecting unit 26 detects a region where the hand is covered with an object, and the estimation result determining unit 24 may determine not to adopt the temperatures of the hand and the face of the occupant estimated by the temperature estimating unit 223 when the region where the hand is covered with the object is equal to or higher than a threshold set in advance (hereinafter, referred to as “object region determination threshold”). As the object region determination threshold, a size of a region is set to such an extent that the temperature of the hand is not sufficiently detected in the temperature image.

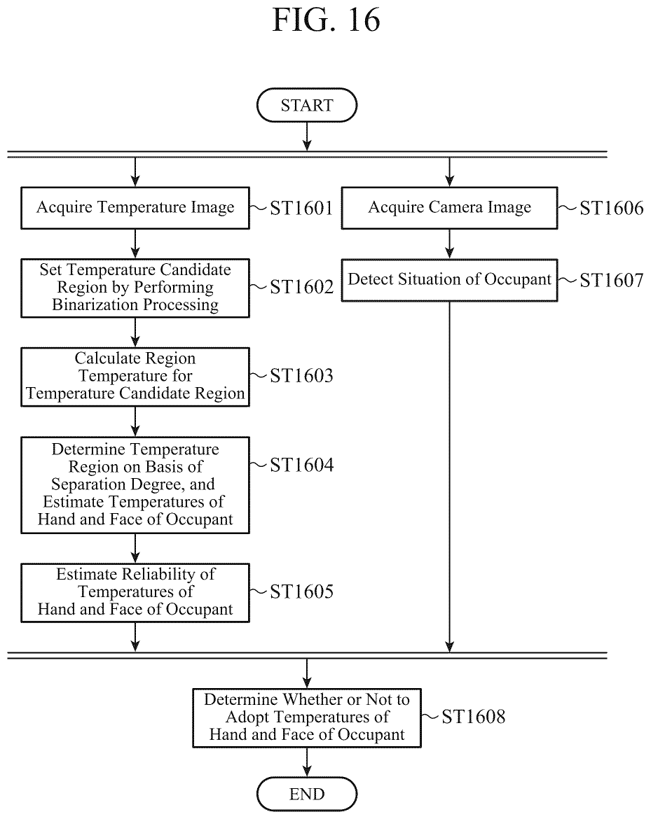

FIG. 16 is a flowchart for explaining an operation of the occupant temperature estimating device 2a that determines whether or not the estimated temperatures of the hand and the face of the occupant are reliable in consideration of a situation of the occupant in the first embodiment.

Since specific operations in steps ST1601 to ST1605 in FIG. 16 are similar to the specific operations in steps ST1301 to ST1305 in FIG. 13 described above, redundant description is omitted.

The camera image acquiring unit 25 acquires a camera image obtained by imaging an occupant in the vehicle interior by the camera 3 (step ST1606).

The camera image acquiring unit 25 outputs the acquired camera image to the situation detecting unit 26.

The situation detecting unit 26 detects the situation of the occupant on the basis of the camera image acquired by the camera image acquiring unit 25 in step ST1606 (step ST1607).

The situation detecting unit 26 outputs information regarding the detected situation of the occupant, specifically, for example, information regarding the region of the occupant's hair in the temperature image or information regarding the face direction angle of the occupant to the estimation result determining unit 24.

When the region of the occupant's hair detected by the situation detecting unit 26 in step ST1607 is equal to or higher than the hair region determination threshold which is set in advance, or when the face direction angle of the occupant detected by the situation detecting unit 26 is equal to or higher than the face direction angle determination threshold, the estimation result determining unit 24 does not adopt the temperature of the face of the occupant estimated by the temperature estimating unit 223 (step ST1608).

In the above description, in the occupant temperature estimating device 2a, the estimation result determining unit 24 does not adopt the temperatures of the hand and the face of the occupant estimated by the temperature estimating unit 223 depending on a detection result of the situation of the occupant detected by the situation detecting unit 26. It is not limited to this, and in the occupant temperature estimating device 2a, for example, the reliability estimating unit 23 may estimate that the reliability of the temperatures of the hand and the face of the occupant estimated by the temperature estimating unit 223 is low depending on a detection result of the situation of the occupant detected by the situation detecting unit 26. Specifically, for example, when the region of the occupant's hair detected by the situation detecting unit 26 is equal to or higher than the hair region determination threshold which is set in advance, or when the face direction angle of the occupant detected by the situation detecting unit 26 is equal to or higher than the face direction angle determination threshold, the reliability estimating unit 23 sets the reliability of the temperatures of the hand and the face of the occupant estimated by the temperature estimating unit 223 to a value lower than the reliability determination threshold.

By the reliability of the estimated temperatures of the hand and the face of the occupant being set to a value lower than the reliability determination threshold by the reliability estimating unit 23, the estimation result determining unit 24 can determine that the temperatures are unreliable and prevent the temperatures from being output.

The information regarding the temperatures of the hand and the face of the occupant estimated by the occupant temperature estimating device 2 according to the first embodiment is used to detect a wakefulness level of the occupant or a sensible temperature of the occupant in an occupant state detection device.

FIG. 17 is a diagram illustrating a configuration example of an occupant state detection device 101 including the occupant temperature estimating device 2 according to the first embodiment.

Note that, in FIG. 17, since the configuration of the occupant temperature estimating device 2 included in the occupant state detection device 101 is similar to the configuration of the occupant temperature estimating device 2 described with reference to FIG. 3, redundant description is omitted.

In FIG. 17, the occupant state detection device 101 includes the occupant temperature estimating device 2 described with reference to FIG. 3, but the occupant state detection device 101 may include the occupant temperature estimating device 2a described with reference to FIG. 14.

The occupant state detection device 101 detects a wakefulness level of the occupant by using information regarding the temperatures of the hand and the face of the occupant estimated by the occupant temperature estimating device 2. In addition, the occupant state detection device 101 detects a sensible temperature of the occupant by using information regarding the temperatures of the hand and the face of the occupant estimated by the occupant temperature estimating device 2.

The occupant state detection device 101 is mounted, for example, on a vehicle.

The occupant state detection device 101 includes the occupant temperature estimating device 2, the wakefulness level detecting unit 4, and the sensible temperature detecting unit 5.

The wakefulness level detecting unit 4 detects the wakefulness level of the occupant on the basis of the temperatures of the hand and the face of the occupant estimated by the occupant temperature estimating device 2.

The wakefulness level detecting unit 4 detects the wakefulness level of the occupant on the basis of a difference between the temperature of the hand of the occupant and the temperature of the face of the occupant. For example, the wakefulness level is detected as being high or being low. When the difference between the temperature of the hand of the occupant and the temperature of the face of the occupant is equal to or lower than a threshold, the wakefulness level detecting unit 4 detects that the wakefulness level of the occupant is low. Note that the above-described method for detecting the wakefulness level is merely an example. The wakefulness level detecting unit 4 may detect the wakefulness level of the occupant using a known technique of detecting the wakefulness level from the temperatures of the hand and the face.

The wakefulness level detecting unit 4 outputs information regarding the detected wakefulness level to, for example, a warning system (not illustrated) or an automatic driving system (not illustrated).

The warning system warns the occupant of the vehicle on the basis of, for example, the wakefulness level detected by the wakefulness level detecting unit 4. Specifically, for example, when it is detected that the wakefulness level is low, the warning system outputs a warning sound from a sound output device mounted on the vehicle, such as a speaker.

The automatic driving system switches driving control of the vehicle to automatic driving control on the basis of, for example, the wakefulness level detected by the wakefulness level detecting unit 4.

Therefore, a driving support function for the occupant is implemented.

The sensible temperature detecting unit 5 detects the sensible temperature of the occupant on the basis of the temperatures of the hand and the face of the occupant. The sensible temperature detecting unit 5 may detect the sensible temperature of the occupant using a known technique of detecting the sensible temperature from the temperatures of the hand and the face.

The sensible temperature detecting unit 5 outputs information regarding the detected sensible temperature to, for example, an air conditioning system (not illustrated).

The air conditioning system controls an air conditioner (not shown) mounted on the vehicle on the basis of, for example, the sensible temperature detected by the sensible temperature detecting unit 5. As a result, air conditioning control comfortable for the occupant is implemented.

An operation of the occupant state detection device 101 according to the first embodiment will be described.

FIG. 18 is a flowchart for explaining the operation of the occupant state detection device 101 according to the first embodiment.

Note that, in the occupant state detection device 101, before the operation illustrated in FIG. 18, the operation of the occupant temperature estimating device 2 described in steps ST1301 to ST1306 in FIG. 13 is performed. Since the operation of FIG. 13 has been described, redundant description is omitted.

When the estimation result determining unit 24 of the occupant temperature estimating device 2 outputs information regarding the temperatures of the hand and the face of the occupant, the wakefulness level detecting unit 4 detects the wakefulness level of the occupant on the basis of the temperatures of the hand and the face of the occupant estimated by the occupant temperature estimating device 2 (step ST1801).

The wakefulness level detecting unit 4 outputs information regarding the detected wakefulness level to, for example, the warning system or the automatic driving system.

The sensible temperature detecting unit 5 detects the sensible temperature of the occupant on the basis of a difference between the temperature of the hand of the occupant and the temperature of the face of the occupant (step ST1802).

The sensible temperature detecting unit 5 outputs information regarding the detected sensible temperature to, for example, the air conditioning system.

Note that, in the flowchart of FIG. 18, the order of the operation in step ST1801 and the operation in step ST1802 may be reversed, or the operation in step ST1801 and the operation in step ST1802 may be performed in parallel.

As described above, the occupant state detection device 101 according to the first embodiment can detect the wakefulness level of the occupant on the basis of the temperatures of the hand and the face of the occupant estimated by the occupant temperature estimating device 2. For example, a driving support function for the occupant is implemented in the warning system or the automatic driving system on the basis of the wakefulness level of the occupant.

In addition, the occupant state detection device 101 according to the first embodiment can detect the sensible temperature of the occupant on the basis of the temperatures of the hand and the face of the occupant estimated by the occupant temperature estimating device 2. Comfortable air conditioning control for the occupant is implemented, for example, in the air conditioning system on the basis of the sensible temperature of the occupant.

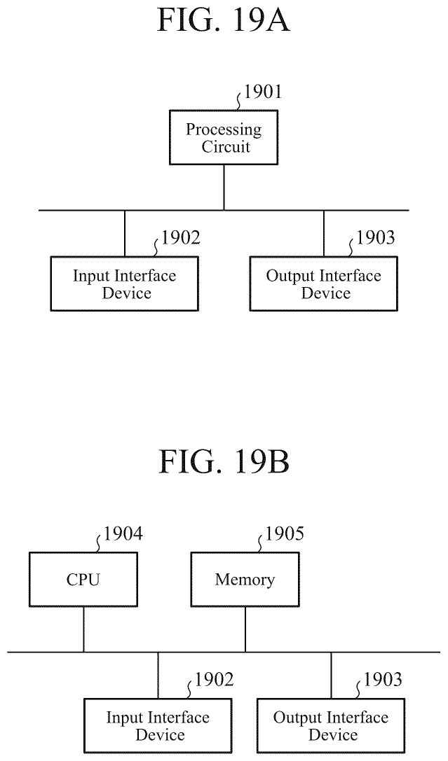

FIGS. 19A and 19B are diagrams each illustrating an example of a hardware configuration of the occupant temperature estimating device 2 according to the first embodiment.

In the first embodiment, the functions of the temperature image acquiring unit 21, the estimation processing unit 22, the reliability estimating unit 23, and the estimation result determining unit 24 are implemented by a processing circuit 1901. That is, the occupant temperature estimating device 2 includes the processing circuit 1901 for estimating temperatures of the hand and the face of the occupant in the vehicle interior on the basis of the temperature image.

The processing circuit 1901 may be dedicated hardware as illustrated in FIG. 19A or a central processing unit (CPU) 1904 for executing a program stored in a memory 1905 as illustrated in FIG. 19B.

When the processing circuit 1901 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 1901.

When the processing circuit 1901 is the CPU 1904, the functions of the temperature image acquiring unit 21, the estimation processing unit 22, the reliability estimating unit 23, and the estimation result determining unit 24 are implemented by software, firmware, or a combination of software and firmware. Software or firmware is described as a program and stored in the memory 1905. By reading and executing the program stored in the memory 1905, the processing circuit 1901 executes the functions of the temperature image acquiring unit 21, the estimation processing unit 22, the reliability estimating unit 23, and the estimation result determining unit 24. That is, the occupant temperature estimating device 2 includes the memory 1905 for storing a program that causes the above-described processes in steps ST1301 to ST1306 illustrated in FIG. 13 to be executed as a result when the program is executed by the processing circuit 1901. It can also be said that the program stored in the memory 1905 causes a computer to execute the procedures or methods performed by the temperature image acquiring unit 21, the estimation processing unit 22, the reliability estimating unit 23, and the estimation result determining unit 24. Here, for example, a nonvolatile or volatile semiconductor memory such as a RAM, a read only memory (ROM), a flash memory, an erasable programmable read only memory (EPROM), or an electrically erasable programmable read-only memory (EEPROM), a magnetic disk, a flexible disk, an optical disc, a compact disc, a mini disc, or a digital versatile disc (DVD) corresponds to the memory 1905.

Note that some of the functions of the temperature image acquiring unit 21, the estimation processing unit 22, the reliability estimating unit 23, and the estimation result determining unit 24 may be implemented by dedicated hardware, and some of the functions may be implemented by software or firmware. For example, the function of the temperature image acquiring unit 21 can be implemented by the processing circuit 1901 as dedicated hardware, and the functions of the estimation processing unit 22, the reliability estimating unit 23, and the estimation result determining unit 24 can be implemented by reading and executing a program stored in the memory 1905 by the processing circuit 1901.

The occupant temperature estimating device 2 includes an input interface device 1902 and an output interface device 1903 that perform wired communication or wireless communication with a device such as the sensor 1.

Note that the hardware configuration of the occupant temperature estimating device 2a is similar to the hardware configuration of the occupant temperature estimating device 2.

The functions of the camera image acquiring unit 25 and the situation detecting unit 26 are implemented by the processing circuit 1901. That is, the occupant temperature estimating device 2a includes the processing circuit 1901 for estimating the temperatures of the hand and the face of the occupant in the vehicle interior on the basis of the temperature image and performing control to determine that the estimated result of the temperature of the hand or the face of the occupant is not adopted depending on a situation of the occupant.

By reading and executing the program stored in the memory 1905, the processing circuit 1901 implements the functions of the camera image acquiring unit 25 and the situation detecting unit 26. That is, the occupant temperature estimating device 2a includes the memory 1905 for storing a program that causes the above-described processes in steps ST1606 and ST1607 illustrated in FIG. 16 to be executed as a result when the program is executed by the processing circuit 1901. It can also be said that the program stored in the memory 1905 causes a computer to execute procedures or methods performed by the camera image acquiring unit 25 and the situation detecting unit 26.

The occupant temperature estimating device 2a includes the input interface device 1902 and the output interface device 1903 that perform wired communication or wireless communication with a device such as the sensor 1 or the camera 3.

The hardware configuration of the occupant state detection device 101 according to the first embodiment is similar to the hardware configuration of the occupant temperature estimating device 2.

The functions of the wakefulness level detecting unit 4 and the sensible temperature detecting unit 5 are implemented by the processing circuit 1901. That is, the occupant state detection device 101 includes the processing circuit 1901 for performing control to detect the wakefulness level or the sensible temperature of the occupant on the basis of the temperatures of the hand and the face of the occupant estimated by the occupant temperature estimating device 2.

By reading and executing the program stored in the memory 1905, the processing circuit 1901 implements the functions of the wakefulness level detecting unit 4 and the sensible temperature detecting unit 5. That is, the occupant state detection device 101 includes the memory 1905 for storing a program that causes the above-described processes in steps ST1801 and ST1802 illustrated in FIG. 18 to be executed as a result when the program is executed by the processing circuit 1901. It can also be said that the program stored in the memory 1905 causes a computer to execute procedures or methods performed by the wakefulness level detecting unit 4 and the sensible temperature detecting unit 5.

The occupant state detection device 101 includes the input interface device 1902 and the output interface device 1903 that perform wired communication or wireless communication with a device such as the sensor 1 or an air conditioner.

In the first embodiment described above, in the occupant temperature estimating device 2, 2a, the binarization processing unit 221 performs Otsu's binarization twice, but this is merely an example, and the binarization processing unit 221 may perform Otsu's binarization only once.

Note that the binarization processing unit 221 can set a temperature candidate region more accurately by performing Otsu's binarization twice.

As described above, since the temperature image is an image having a medium or lower resolution, a boundary between the occupant's hand and a portion other than the occupant's hand or a boundary between the occupant's face and a portion other than the occupant's face is blurred on the temperature image. Therefore, when Otsu's binarization is performed only once, the boundary is not clear, and a relatively large region including the hand or the face of the occupant is set as a temperature candidate region.

By performing Otsu's binarization twice, the binarization processing unit 221 can further narrow down the temperature candidate region. Therefore, the binarization processing unit 221 can set a temperature candidate region which includes relatively central portions of the hand and the face of the occupant and which is more separated from the surroundings. As a result, when determining a temperature region, the temperature estimating unit 223 can determine that a temperature candidate region which includes relatively central portions of the hand and the face of the occupant and which is more separated is the temperature region, and thereby the estimation accuracy of the temperatures of the hand and the face of the occupant can be enhanced.

In the first embodiment described above, the binarization processing unit 221 creates a binary image in which pixels in the target region are binarized by performing Otsu's binarization, but this is merely an example. The binarization processing unit 221 may binarize pixels in the target region by a method other than Otsu's binarization. For example, the binarization processing unit 221 may binarize pixels in the target region using another known image processing means.

In the first embodiment described above, the occupant temperature estimating device 2, 2a includes the reliability estimating unit 23 and the estimation result determining unit 24, but does not have to include the reliability estimating unit 23 and the estimation result determining unit 24 necessarily.

In the first embodiment described above, the occupant temperature estimating device 2, 2a is an in-vehicle device mounted on a vehicle, and the temperature image acquiring unit 21, the estimation processing unit 22, the reliability estimating unit 23, the estimation result determining unit 24, the camera image acquiring unit 25, and the situation detecting unit 26 are included in the occupant temperature estimating device 2, 2a. It is not limited to this, and some of the temperature image acquiring unit 21, the estimation processing unit 22, the reliability estimating unit 23, the estimation result determining unit 24, the camera image acquiring unit 25, and the situation detecting unit 26 may be mounted on an in-vehicle device of a vehicle, and the others may be included in a server connected to the in-vehicle device via a network. In this manner, the in-vehicle device and the server may constitute a system.

In the first embodiment described above, the occupant state detection device 101 includes the occupant temperature estimating device 2, the wakefulness level detecting unit 4, and the sensible temperature detecting unit 5, but this is merely an example. For example, any one of the occupant temperature estimating device 2, the wakefulness level detecting unit 4, and the sensible temperature detecting unit 5 may be disposed outside the occupant state detection device 101.

In the first embodiment described above, the body part of the occupant is the hand or the face, but this is merely an example. The occupant temperature estimating device 2, 2a may estimate the temperature of a body part of the occupant other than the hand and the face. The occupant temperature estimating device 2, 2a only needs to estimate the temperature of at least one of the hand and the face of the occupant.

In the first embodiment described above, the occupant is assumed to be a driver of the vehicle, but this is merely an example. The occupant may be, for example, an occupant other than the driver, such as an occupant in an assistant driver's seat.

As described above, according to the first embodiment, the occupant temperature estimating device 2, 2a includes: the temperature image acquiring unit 21 that acquires a temperature image which is obtained by imaging a vehicle interior and whose pixels each have temperature information; the binarization processing unit 221 that sets at least one temperature candidate region in a target region from which a temperature of a body part of an occupant present in the vehicle interior is to be estimated, by binarizing pixels in the target region on the basis of the temperature information possessed by the pixels in the target region, the target region being included in a region of the temperature image acquired by the temperature image acquiring unit 21; the candidate region temperature calculating unit 222 that calculates a region temperature for the temperature candidate region in the target region on the basis of the temperature information possessed by a pixel in the temperature candidate region; and the temperature estimating unit 223 that determines a temperature region from among the at least one temperature candidate region on the basis of a separation degree indicating how much the temperature information possessed by the pixel in the temperature candidate region stands out from the temperature information possessed by a pixel in a region other than the temperature candidate region in the target region, the separation degree being calculated for the temperature candidate region in the target region, and estimates that the temperature of the body part of the occupant is the region temperature for the temperature region.

Therefore, the occupant temperature estimating device 2, 2a can enhance estimation accuracy of the temperatures of the hand and the face of the occupant based on the temperature image as compared with a conventional temperature estimating technique based on the temperature image.

In addition, the occupant temperature estimating device 2, 2a can accurately estimate the temperatures of the hand and the face of the occupant even from a temperature image having a medium or lower resolution.

In addition, according to the first embodiment, the occupant temperature estimating device 2, 2a includes: the reliability estimating unit 23 that estimates reliability of the temperature of the body part of the occupant estimated by the temperature estimating unit 223; and the estimation result determining unit 24 that determines whether or not to adopt the temperature of the body part of the occupant estimated by the temperature estimating unit 223 by comparing the reliability estimated by the reliability estimating unit 23 with the reliability determination threshold.

Therefore, the occupant temperature estimating device 2, 2a can further enhance the estimation accuracy of the temperatures of the hand and the face of the occupant based on the temperature image, and can prevent an estimation result with a low reliability among the estimation results of the temperatures of the hand and the face of the occupant from being used in another device or the like.

Note that, in the present disclosure, any component in the embodiment can be modified, or any component in the embodiment can be omitted.

### INDUSTRIAL APPLICABILITY

The occupant temperature estimating device according to the present disclosure can enhance estimation accuracy of the temperatures of the hand and the face of the occupant based on the temperature image as compared with a conventional temperature estimating technique based on the temperature image.

### REFERENCE SIGNS LIST

1: sensor, 2, 2a: occupant temperature estimating device, 3: camera, 4: wakefulness level detecting unit, 5: sensible temperature detecting unit, 21: temperature image acquiring unit, 22: estimation processing unit, 221: binarization processing unit, 2211: target region extracting unit, 222: candidate region temperature calculating unit, 223: temperature estimating unit, 23: reliability estimating unit, 24: estimation result determining unit, 25: camera image acquiring unit, 26: situation detecting unit, 100: occupant temperature estimating system, 101: occupant state detection device, 231: machine learning model, 1901: processing circuit, 1902: input interface device, 1903: output interface device, 1904: CPU, 1905: memory

1. An occupant temperature estimating device comprising:
processing circuitry
to acquire a temperature image which is obtained by imaging a vehicle interior and whose pixels each have temperature information;
to set at least one temperature candidate region in a target region from which a temperature of a body part of an occupant present in the vehicle interior is to be estimated, by binarizing pixels in the target region on a basis of the temperature information possessed by the pixels in the target region, the target region being included in a region of the acquired temperature image;
to calculate a region temperature for the temperature candidate region in the target region on a basis of the temperature information possessed by a pixel in the temperature candidate region; and
to determine a temperature region from among the at least one temperature candidate region on a basis of a separation degree indicating how much the temperature information possessed by the pixel in the temperature candidate region stands out from the temperature information possessed by a pixel in a region other than the temperature candidate region in the target region, the separation degree being calculated for the temperature candidate region in the target region, and to estimate that the temperature of the body part of the occupant is the region temperature for the temperature region.

2. The occupant temperature estimating device according to claim 1, wherein:
the processing circuitry estimates reliability of the estimated temperature of the body part of the occupant; and
the processing circuitry determines whether or not to adopt the estimated temperature of the body part of the occupant by comparing the estimated reliability with a reliability determination threshold.

3. The occupant temperature estimating device according to claim 1, wherein
the body part of the occupant is at least one of a hand and a face of the occupant.

4. The occupant temperature estimating device according to claim 1, wherein
the processing circuitry
binarizes the pixels in the target region by Otsu's binarization on a basis of the temperature information possessed by the pixels in the target region.

5. The occupant temperature estimating device according to claim 1, wherein
the processing circuitry
classifies the pixels in the target region into a high temperature region and a low temperature region depending on whether or not corresponding temperature is equal to or higher than a temperature determination threshold on a basis of the temperature information possessed by the pixels in the target region, groups pixels classified into the high temperature region, and thereby sets the temperature candidate region.

6. The occupant temperature estimating device according to claim 2, wherein
the processing circuitry
estimates the reliability on a basis of the calculated region temperature, the separation degree, an area of a circumscribed rectangle circumscribing the temperature region, position information of the circumscribed rectangle in the target region, a horizontal length of the circumscribed rectangle, and a vertical length of the circumscribed rectangle.

7. The occupant temperature estimating device according to claim 2, wherein
the processing circuitry
estimates the reliability using a machine learning model to receive, as inputs, the calculated region temperature, the separation degree, an area of a circumscribed rectangle circumscribing the temperature region, position information of the circumscribed rectangle in the target region, a horizontal length of the circumscribed rectangle, and a vertical length of the circumscribed rectangle, and to output the reliability.

8. The occupant temperature estimating device according to claim 2, wherein:
the processing circuitry acquires a camera image obtained by imaging the occupant,
the processing circuitry detects a region of the occupant's hair or a face direction angle of the occupant in the temperature image on a basis of a region of the occupant's hair or a face direction angle of the occupant in the acquired camera image, and
the processing circuitry does not adopt the estimated temperature of the body part of the occupant when the detected region of the occupant's hair is equal to or higher than a hair region determination threshold, or when the detected face direction angle of the occupant is equal to or higher than a face direction angle determination threshold.

9. An occupant state detection device comprising:
the occupant temperature estimating device according to claim 1, wherein
the processing circuitry detects a wakefulness level of the occupant using the temperature of a hand or a face of the occupant estimated by the occupant temperature estimating device.

10. An occupant state detection device comprising:
the occupant temperature estimating device according to claim 1, wherein
the processing circuitry detects a sensible temperature of the occupant using the temperature of a hand or a face of the occupant estimated by the occupant temperature estimating device.

11. An occupant temperature estimating method comprising:
acquiring a temperature image which is obtained by imaging a vehicle interior and whose pixels each have temperature information;
setting at least one temperature candidate region in a target region from which a temperature of a body part of an occupant present in the vehicle interior is to be estimated, by binarizing pixels in the target region on a basis of the temperature information possessed by the pixels in the target region, the target region being included in a region of the acquired temperature image;
calculating a region temperature for the temperature candidate region in the target region on a basis of the temperature information possessed by a pixel in the temperature candidate region; and
determining a temperature region from among the at least one temperature candidate region on a basis of a separation degree indicating how much the temperature information possessed by the pixel in the temperature candidate region stands out from the temperature information possessed by a pixel in a region other than the temperature candidate region in the target region, the separation degree being calculated for the temperature candidate region in the target region, and estimating that the temperature of the body part of the occupant is the region temperature for the temperature region.

12. An occupant temperature estimating system comprising:
a sensor to image a temperature image which is obtained by imaging a vehicle interior and whose pixels each have temperature information; and
processing circuitry
to acquire the temperature image imaged by the sensor;
to set at least one temperature candidate region in a target region from which a temperature of a body part of an occupant present in the vehicle interior is to be estimated, by binarizing pixels in the target region on a basis of the temperature information possessed by the pixels in the target region, the target region being included in a region of the acquired temperature image;
to calculate a region temperature for the temperature candidate region in the target region on a basis of the temperature information possessed by a pixel in the temperature candidate region; and
to determine a temperature region from among the at least one temperature candidate region on a basis of a separation degree indicating how much the temperature information possessed by the pixel in the temperature candidate region stands out from the temperature information possessed by a pixel in a region other than the temperature candidate region in the target region, the separation degree being calculated for the temperature candidate region in the target region, and to estimate that the temperature of the body part of the occupant is the region temperature for the temperature region.

13. The occupant temperature estimating system according to claim 12, wherein
the sensor is an infrared array sensor.
